(19) United States
(12) Patent Application Publication
(10) Pub. No.: US 2011/0257940 A1
(43) Pub. Date: Oct. 20, 2011

(54) VISUAL NOTIFICATION TOOL

(75) Inventor: Ernesto Vega, Metuchen, NJ (US)

(73) Assignee: SIMPLEXGRINNELL LP, Westminster, MA (US)

(21) Appl. No.: 13/087,801

(22) Filed: Apr. 15, 2011

Related U.S. Application Data
(60) Provisional application No. 61/324,921, filed on Apr. 16, 2010.

(51) Int. Cl. G06F 17/50

(52) U.S. Cl. 703/1

(57) ABSTRACT

Techniques for visual notification appliance selection are described. A set of dimensions for a structure are received by a processor and stored on a computer-readable storage medium. The processor calculates a maximum distance between a mounting location for a visual notification appliance and a location within the structure based upon the received dimensions. The processor also estimates an illuminance value for each of a plurality of angular paths within the structure. A visual notification appliance is selected that has an illumination rating that produces a minimum illuminance value at the maximum distance and at each of the plurality of angular paths. Other embodiments are described and claimed.

### CROSS-REFERENCE TO RELATED APPLICATIONS

This application claims priority to U.S. Provisional Patent Application No. 61/324,921 filed on Apr. 16, 2010, which is herein incorporated by reference in its entirety.

### FIELD OF THE INVENTION

Embodiments of the present disclosure relate to a tool for selecting a visual notification appliance with an illuminance rating that is compliant with regulatory requirements. More particularly, the present disclosure relates to calculating the estimated illuminance for a visual notification appliance based upon received room dimensions. A recommendation for a specific visual notification appliance illuminance rating is given such that the visual notification appliance provides at least the minimum required illuminance within the given room dimensions according to regulatory requirements.

### DISCUSSION OF RELATED ART

Visual notification appliances, e.g. warning lights or strobe lights, are often used within buildings in conjunction with audio warning alarms so that the hearing impaired can be alerted to emergency conditions, such as a fire. Typically, the visual notification appliance includes a flashing bulb or strobe positioned within a reflector. The bulb receives power from a power supply in a control panel. This power supply is normally powered by the building's AC supply, but also provides battery backup to ensure that the visual notification appliance will have power in the event power to the building is disrupted.

The flash bulb or strobe of a visual notification appliance may be made up of a high-intensity xenon flash tube, a reflector assembly, a transparent protective dome, an electronic control circuit, a terminal block and a housing to accommodate installation of the device to a wall or ceiling. In various embodiments, the strobe of a visual notification appliance is designed to disperse its light output in a hemispherical pattern. The light distribution must meet the stringent specifications for UL approval, and it typically must accurately flash at a specified rate, for example, once per second or at some other multiple. Strobes in the same viewing area typically must be synchronized, as a fast flash rate or several unsynchronized strobes at the normal rate could cause susceptible people to have epileptic seizures.

Visual notification appliances are subject to light intensity requirements as specified in various standards, such as Underwriters Laboratories UL 1971 (as well as UL 1638), “Standard for Safety Signaling Devices for the Hearing Impaired,” and the National Fire Protection Association's NFPA 72, The National Fire Alarm Code, all of which are incorporated herein by reference in their entirety. For example, according to NFPA 72 A.7.5.4.3, “A design that delivers 0.0375 lumens/ft² (0.4037 lumens/m²) effective intensity to all occupied areas where visible notification is required is considered to meet the minimum light intensity requirements of 7.5.4.1.2(1).”

As documented within UL 1971, the effective intensity of a visual notification appliance is measured in candela (cd) and is based upon a measure of the average light produced by the visual notification appliance, e.g. a strobe light, and comparing that to the illumination of a steady light. The effective intensity is used as a rating for the visual notification device and does not reflect the illumination provided at a given distance. However, the illumination, or illuminance, reaching a specified distance from a visual notification appliance may allow the effective intensity to be accurately calculated. This may be calculated using the inverse-square law applied to light measurements, set forth within the equation, P=I/D², where P is the illuminance in lumens/ft², I is the effective intensity or candela rating and D is the distance in feet.

The aforementioned standards typically provide guidance in the form of tables that include exemplary room dimensions and corresponding acceptable visual notification appliance illuminance. For example, Table 1 illustrates exemplary guidance provided by the NFPA 72.

TABLE 1
MINIMUM REQUIRED LIGHT OUTPUT (cd)

| | | Two | Four | | |
|---|---|---|---|---|---|
| | One | Lights | Lights | | |
| Maximum | Light | Per | Per | | |
| Room | Per | Room - | Room - | Maximum | |
| Size | Room | Opposite | One Each | Ceiling | One Light |
| (ft) | (cd) | Walls (cd) | Wall (cd) | Height (ft) | (cd) |
| 20′ × 20′ | 15 | — | — | 10′, 20′, 30′ | 15, 30, 50 |
| 30′ × 30′ | 34 | 15 | — | 10′, 20′, 30′ | 30, 45, 75 |
| 40′ × 40′ | 60 | 30 | 15 | 10′, 20′, 30′ | 60, 80, 115 |
| 50′ × 50′ | 94 | 60 | 30 | 10′, 20′, 30′ | 95, 115, 150 |
| 60′ × 60′ | 135 | 95 | 30 | — | — |
| 70′ × 70′ | 184 | 95 | 60 | — | — |

As illustrated within Table 1 above, only a small set of predefined dimensions, such as square rooms or ceiling heights of 10′, 20′ and 30′, are given as guidance by the regulatory bodies. However, engineers may need to choose visual notification appliances for irregular-shaped rooms or structures that are not included within such regulatory guidelines. One solution may be to simply use the recommendation for dimensions as close as possible to the dimensions of an irregularly shaped room. Using the closest acceptable visual notification appliance may satisfy the regulatory requirements; however, this technique may provide more illumination than necessary, which can increase cost significantly. Furthermore, there is no certainty that all points of an irregularly shaped room are properly illuminated. Therefore, a need exists for a tool that can use any dimensions to select a visual notification appliance with an illumination rating that meets the necessary regulatory requirements.

### SUMMARY OF THE INVENTION

The following presents a simplified summary in order to provide a basic understanding of some novel embodiments described herein. This summary is not an extensive overview, and it is not intended to identify key elements or to delineate the scope thereof. Its sole purpose is to present some concepts in a simplified form as a prelude to the more detailed description that is presented later.

Various embodiments are generally directed to techniques for visual notification appliance selection. A set of dimensions for a structure are received by a processor and stored on a computer-readable storage medium. The processor calculates a maximum distance between a mounting location for a visual notification appliance and a location within the structure based upon the received dimensions. The processor also estimates an illuminance value for each of a plurality of angular paths within the structure. A visual notification appliance is selected that has an illumination rating that produces a minimum illuminance value at the maximum distance and at each of the plurality of angular paths. Other embodiments are described and claimed.

To accomplish the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1A illustrates a diagram of irregularly shaped structures.

FIG. 1B illustrates an embodiment of a user interface of a visual notification tool.

FIG. 2 illustrates a measurement diagram for an embodiment of a visual notification tool.

FIG. 3 illustrates a measurement diagram for an embodiment of a visual notification tool.

FIG. 4 illustrates a measurement diagram for an embodiment of a visual notification tool.

FIG. 5 illustrates a logic flow for an embodiment of a visual notification tool.

FIG. 6 illustrates a computing system for an embodiment of a visual notification tool.

### DESCRIPTION OF EMBODIMENTS

Various embodiments are directed to techniques for selecting appropriate visual notification appliances for a particular location or structure. A set of dimensions for a structure are received by a processor and stored on a computer-readable storage medium. The dimensions may include the height, width and depth of a structure, such as a room in a building. In addition, a mounting location, such as a wall or ceiling may be received as input. The processor calculates a maximum distance between the mounting location for a visual notification appliance and a location within the structure based upon the received dimensions. The illuminance at the maximum distance is estimated. The processor also estimates an illuminance value for each of a plurality of angular paths within the structure. For example, in the case of a wall mounted visual notification appliance, illuminance for both horizontal and vertical angles will be estimated. In the case of a ceiling mounted visual notification appliance, illuminance for polar angles will be estimated. The specific angles for horizontal, vertical and polar estimates may be set forth within a safety standard, such as UL 1971.

In one embodiment, a visual notification appliance is selected that has an illumination rating that produces a minimum illuminance value at the maximum distance and at each of the plurality of angular paths. For example, a minimum illuminance value may be set by a safety standard. In an exemplary embodiment, the minimum illuminance value may be 0.0375 lumens/ft². Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives falling within the spirit and scope of the claimed subject matter.

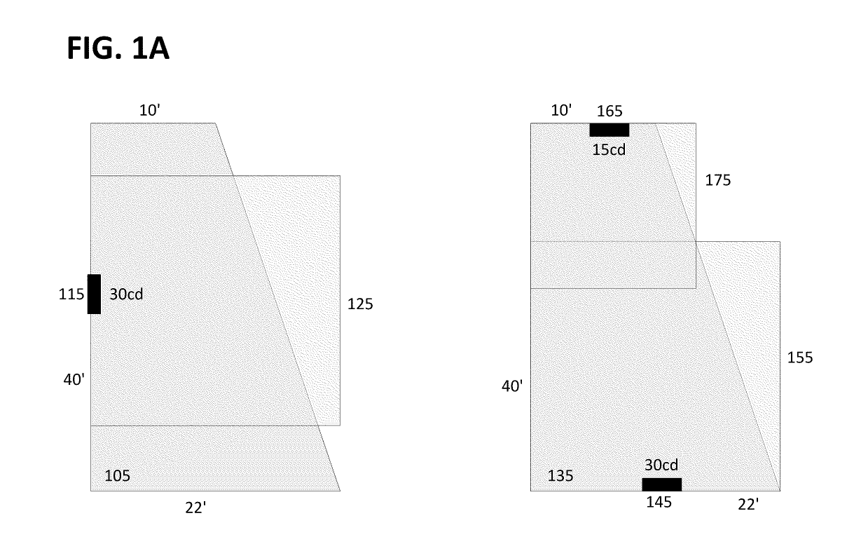

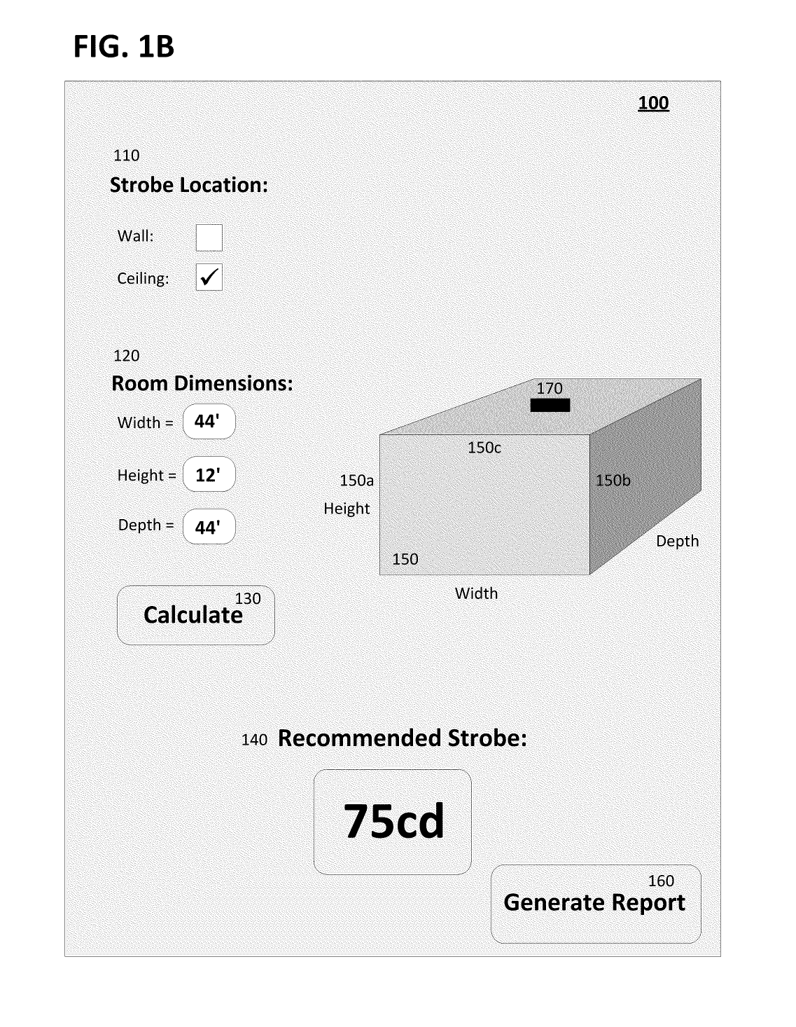

FIG. 1A illustrates irregularly shaped structures 105 and 135 in which an embodiment of the present disclosure may be used to determine the appropriate illuminance associated with one or more notification appliances. As illustrated, structures 105 and 135 have dimensions of 40′×22′×10′. This room size is not provided for within Table 1, for example. Visual notification appliance 115, with a candela rating of 30cd, may provide sufficient illumination within coverage area 125 for regulatory compliance, however, as illustrated, coverage area 125 is not large enough to cover all of structure 105. For example, the corners of structure 105 are not included within coverage area 125. Instead, a visual notification appliance with a higher candela rating, or multiple visual notification appliances may be necessary to provide sufficient coverage.

Structure 135 includes two visual notification appliances, 145 and 165. Visual notification appliance 145, with a candela rating of 30cd, provides regulatory sufficient illumination within coverage area 155. Visual notification appliance 165, with a candela rating of 15cd, provides regulatory sufficient illumination within coverage area 175. As illustrated, the combination of visual notification appliances 145 and 165 provides sufficient coverage over the entire structure 135. Alternatively, a single visual notification appliance with a higher candela rating may provide coverage for all of structure 135. The embodiments are not limited by this example.

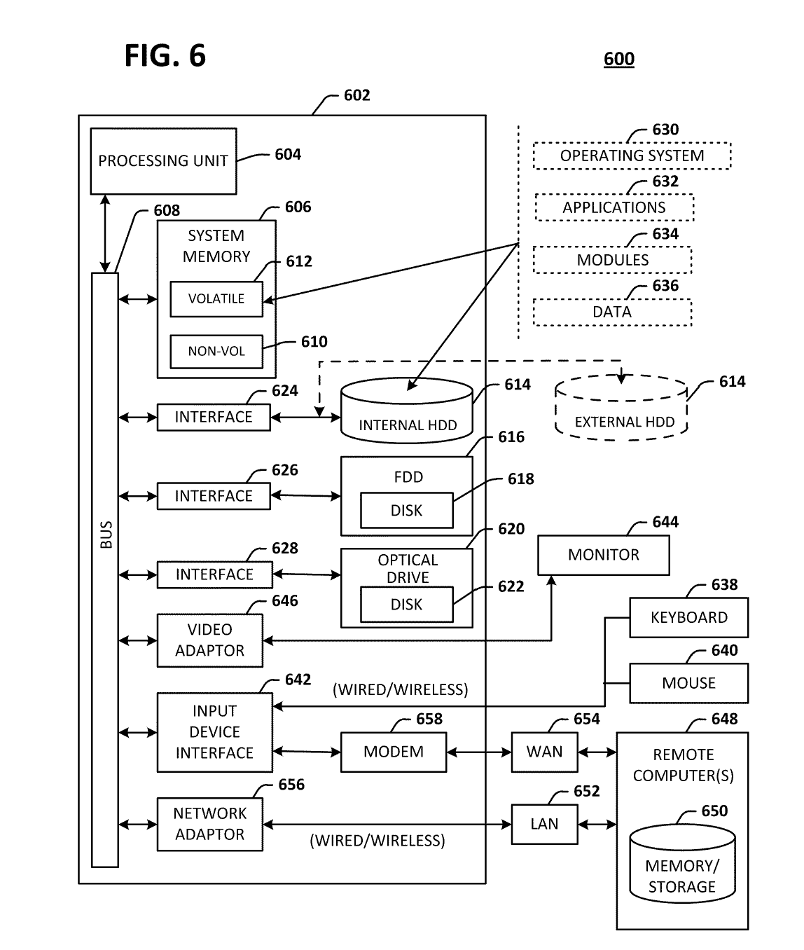

FIG. 1B illustrates an embodiment of a user interface of an exemplary visual notification tool. User interface 100 is a graphical user interface that may be displayed on a display device by a processor, which are part of a computing system, such as that illustrated in FIG. 6. User interface 100 may be web-based or application-based and may access data stored locally or remotely. User-interface may be a part of a visual notification tool, which comprises instructions stored on a non-transitory computer-readable storage medium and executed by a processor. User interface 100 includes element 110, which lists two locations for the positioning of visual notification appliances, such as one or more strobe lights. In particular, a user may select a wall mounting location or a ceiling mounting location, or both, by checking the respective box or boxes of element 110. A specific location on the wall or ceiling may be chosen by the application based upon prescribed regulations. For example, in accordance with NFPA 72, a wall-mounted strobe light must be installed at no less than 80″ and not greater than 96″ above finished floors. The visual notification tool uses one or both of these locations to select a compliant visual notification appliance. In an alternative embodiment, the user interface may allow a user to input the exact mounting location of each visual notification appliance, for example, using an additional user interface element within user interface 100. The embodiments are not limited to this example.

Element 120 accepts an input of dimensions for structure 150, which may be, for example, a room or area within a building. The dimensions include the width, height and depth of the structure 150 having opposed walls 150a, 150b, and ceiling 150c. The dimensions may be irregular dimensions, such as those not provided for within regulatory guidelines. As illustrated, a width of 44′, a height of 12′ and a depth of 44′ have been entered. A room that is 44′×44′ is not included within the regulatory guidelines, as illustrated within Table 1. The guidelines only provide for rooms with dimensions of 40′×40′ or 50′×50′, for example. The visual notification tool, however, may provide a recommendation for an appropriate visual notification appliance for a room having such an irregular size. Using the entered mounting location (wall and/or ceiling) and room dimensions, the visual notification tool calculates an illuminance at a maximum distance and at a plurality of angular paths from the mounting location to determine a particular type (e.g. candela rating) of visual notification appliance appropriate for structure 150.

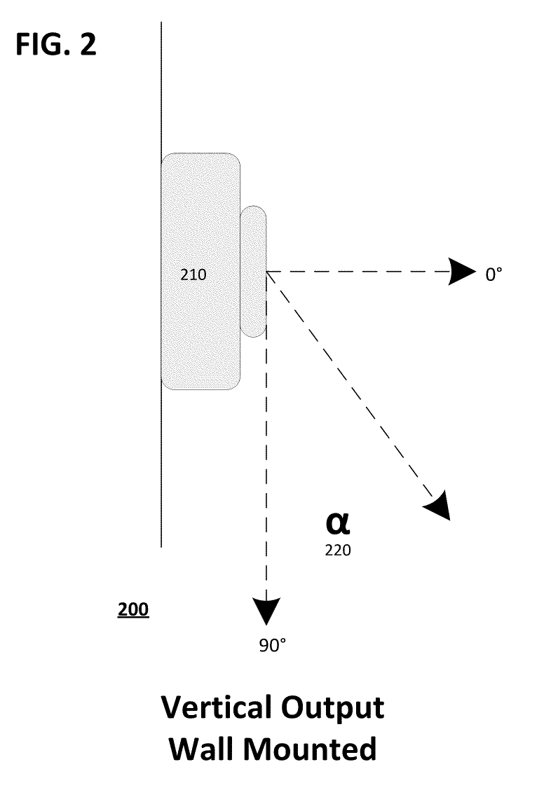

Using the entered mounting location and room dimensions, the visual notification tool calculates the maximum distance from the mounting location to any point within structure 150 using geometric triangulation. The maximum distance may be, for example, a distance from the mounting location to the farthest corner of the room. The location of the visual notification appliance 170, including its placement on the ceiling 150c, distance from opposed walls 150a, 150b and height above the floor, is taken as a reference point as well as an angle α to the most remote point within the room as described with more particularity with reference to FIGS. 2-4. For example, if a strobe is to be installed on the wall 150a, the visual notification tool will use a strobe mounting location in the middle of the wall 150a at either 80″ or 96″ above the finished floor, as required by ADA and NFPA requirements, for example. Other values may be used based upon design considerations or applicable regulations. The angle to the most remote point within the room is calculated using the equation, α=(ATAN(h/Room Width))*(180%) where ATAN represents the inverse of tangent function and the value for h is the height in inches above the finished floor of the strobe mounting location which may be, for example, 80″ or 96″ as discussed above, or may change based upon design considerations or applicable regulations. The same concept of geometric triangulation applies for the calculation of maximum distance for ceiling mounted strobes.

The maximum distance represents the maximum distance for illumination from a visual notification appliance. For example, the maximum distance may be the distance from the mounting location to the farthest corner of the room. In particular, the illuminance value may be calculated using the inverse-square law applied to light measurements set forth within the equation, P=I/D², where P is the illuminance in lumens/ft², I is the effective intensity or candela rating of a visual notification appliance and D is the distance in feet.

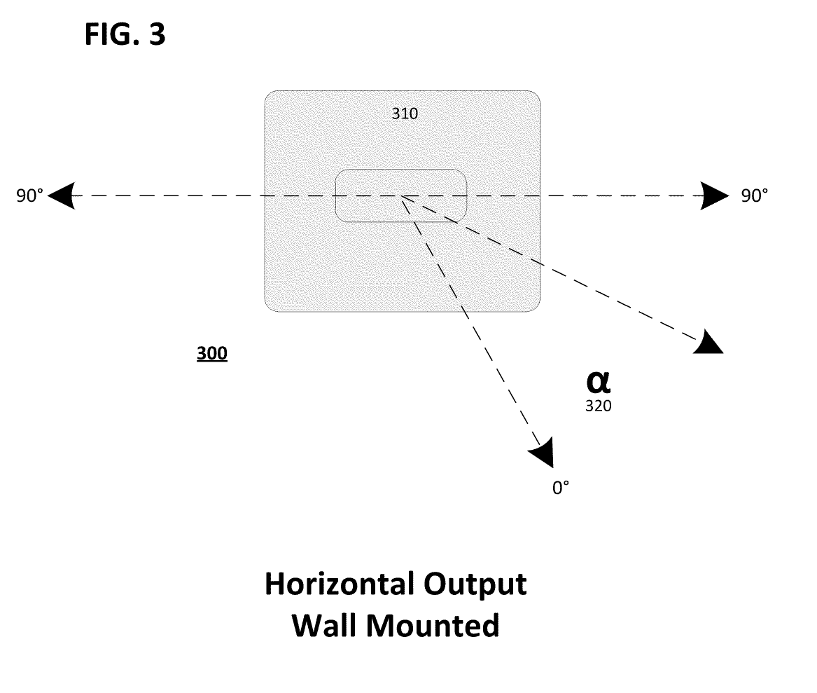

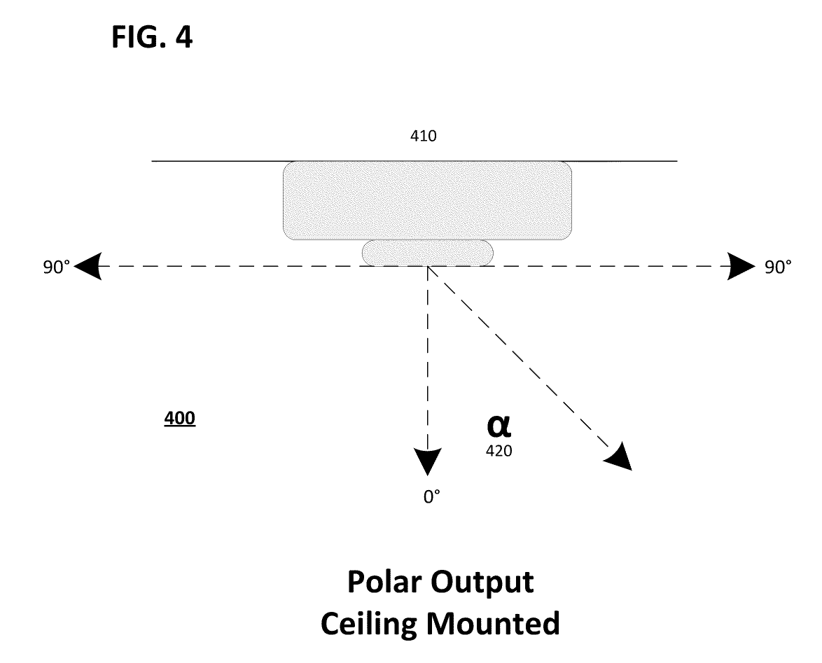

In an embodiment, the visual notification tool estimates an illuminance value for each of a plurality of angular paths from the chosen mounting location. In particular, these angular paths are defined using the mounting location of a visual notification appliance as a reference point and selecting paths to the furthest point within a structure at each of a plurality of angles, such as those illustrated within FIGS. 2-4. The illuminance value may be calculated for each angular path using the inverse-square law. For example, in the case of a wall mounted visual notification appliance, as illustrated in FIGS. 2 and 3, illuminance values for both horizontal and vertical angles from the mounting location will be estimated. In the case of a ceiling mounted visual notification appliance, illuminance for polar angles will be estimated, as illustrated in FIG. 4. A subset of angles will be chosen for each estimate. The specific subset of angles chosen for horizontal, vertical and polar estimates may be set forth within a safety standard, such as UL 1971. The embodiments are not limited by this example.

Element 130 allows a user to activate the visual notification tool. The visual notification tool selects a particular visual notification appliance, such as a strobe light. Alternatively, the visual notification tool may select a particular illuminance rating for a visual notification appliance. Element 140 displays a selected visual notification appliance or illuminance rating. In addition to displaying an illuminance rating, the visual notification tool may also display a product number or price for a particular visual notification appliance.

The visual notification tool may consider a predetermined set of different visual notification appliances or illuminance ratings. For example, illuminance ratings of 15cd, 30cd, 45cd, 50cd, 60cd, 75cd, 80cd, 95cd, 115cd and 150cd may be considered. This information may be selected from a database of commercially available products. The database of commercially available products may be periodically updated to reflect new products or the supply of existing products. A visual notification appliance is selected such that a minimum illuminance value is achieved at the maximum distance and at each of the plurality of angular paths. The minimum illuminance value may be set by a safety standard. For example, the minimum illuminance value may be 0.0375 lumens/ft². In an embodiment, a visual notification appliance may be chosen such that it is the least expensive to purchase or least expensive to operate; yet still meets the minimum illuminance value. Further, a predetermined minimum illuminance rating may be set, such as 75cd at a distance of 50 feet on-axis. In this manner, a minimum level of illuminance will be recommended. The embodiments are not limited by the example.

Element 160 may be selected by a user to generate a report. An exemplary report is included at Appendix A. The visual notification tool may generate a report automatically by the visual notification tool according to a document template stored locally on a computer-readable storage medium or remotely on a connected server. A report may include a letter to an authority that sets forth the data input into the visual notification tool by the user, the mathematical calculations performed, the results of all calculations and estimations, the recommended visual notification appliance, the cost of the recommended visual appliances or the cost savings generated by the visual notification tool. The report may list each angular path estimated along with a corresponding estimated illuminance from a mounting location to the end of the angular path. Further, the report may indicate the maximum distance calculated and the estimated illuminance from a mounting location to the end of a path of the maximum distance. With each estimated illuminance, the report may indicate whether the estimated illuminance passes or fails a particular regulation, such as meeting a minimum illuminance value. The embodiments are not limited by the example.

The generated report may be in the form of an email or other electronic document. The visual notification tool may give the option to download the report, upload directly to an authority, send to a particular email address or print to a printing device locally or remotely.

FIG. 2 illustrates a measurement diagram 200 for an embodiment of a visual notification tool. Diagram 200 includes visual notification appliance 210, which may be a strobe light or other notification light used to alert individuals of hazardous conditions within a building. Diagram 200 illustrates a vertical output of a wall mounted visual notification device. As described above, the visual notification tool estimates the illuminance along with a predetermined set of angular paths from a mounting location. For wall mounted visual notification appliances, both vertical and horizontal angular paths are estimated. Angle 220 represents a vertical angular path to be estimated by the visual notification tool. For example, the illuminance at the end of an angular path at a predetermined set of angles between 0 degrees and 90 degrees may be estimated. The predetermined set of angles may be chosen using available standards, such as the UL 1971. Table 2 illustrates a set of predetermined angles as set forth within the UL 1971. Each angle is associated with a vertical output rating, which is a percentage of the output to be expected at the corresponding angle. In an embodiment, the visual notification tool estimates an illuminance value for an angular path at each of the angles within Table 2. The visual notification tool also estimates an illuminance value at an angle that corresponds to a maximum distance from the mounting location to a point within the structure, such as the farthest corner from the mounting location, for example.

TABLE 2

| Angle (Deg) | Vertical Output (%) |
|---|---|
| 0 | 100 |
| 5-30 | 90 |
| 35 | 65 |
| 40 | 46 |
| 45 | 34 |
| 50 | 27 |
| 55 | 22 |
| 60 | 18 |
| 65 | 16 |
| 70 | 15 |
| 75 | 13 |
| 80 | 12 |
| 85 | 12 |
| 90 | 12 |

FIG. 3 illustrates a measurement diagram 300 for an embodiment of a visual notification tool. Diagram 300 includes visual notification appliance 310, which may be a strobe light or other notification light used to alert individuals of hazardous conditions within a building. Diagram 300 illustrates a horizontal output of a wall mounted visual notification device. As described above, the visual notification tool estimates the illuminance along a predetermined set of angular paths from a mounting location. For wall mounted visual notification appliances, both vertical and horizontal angular paths are estimated. Angle 320 represents a horizontal angular path to be estimated by the visual notification tool. For example, the illuminance at the end of an angular paths at a predetermined set of angles between 0 degrees and 90 degrees may be estimated. In an embodiment, the angle at 0 degrees as illustrated within FIG. 3 corresponds to the angle at 0 degrees as illustrated within FIG. 2. The predetermined set of angles may be chosen using available standards, such as the UL 1971. Table 3 illustrates a set of predetermined angles as set forth within the UL 1971. Each angle is associated with a horizontal output rating, which is a percentage of the output to be expected at the corresponding angle. In an embodiment, the visual notification tool estimates an illuminance value for an angular path at each of the angles within Table 3. The visual notification tool also estimates an illuminance value at an angle that corresponds to a maximum distance from the mounting location to a point within the structure, such as the farthest corner from the mounting location, for example.

TABLE 3

| Angle (Deg) | Horizontal Output (%) |
|---|---|
| 0 | 100 |
| 5-25 | 90 |
| 30-45 | 75 |
| 50 | 55 |
| 55 | 45 |
| 60 | 40 |
| 65 | 35 |
| 70 | 35 |
| 75 | 30 |
| 80 | 30 |
| 85 | 25 |
| 90 | 25 |

FIG. 4 illustrates a measurement diagram 400 for an embodiment of a visual notification tool. Diagram 400 includes visual notification appliance 410, which may be a strobe light or other notification light used to alert individuals of hazardous conditions within a building. Diagram 400 illustrates a polar output of a ceiling mounted visual notification device. As described above, the visual notification tool estimates the illuminance along a predetermined set of angular paths from a mounting location. For ceiling mounted visual notification appliances, polar angular paths are estimated. Angle 420 represents a polar angular path to be estimated by the visual notification tool. For example, the illuminance at the end of an angular paths at a predetermined set of angles between 0 degrees and 90 degrees may be estimated. The predetermined set of angles may be chosen using available standards, such as the UL 1971. Table 4 illustrates a set of predetermined angles as set forth within the UL 1971. Each angle is associated with a polar output rating, which is a percentage of the output to be expected at the corresponding angle. In an embodiment, the visual notification tool estimates an illuminance value for an angular path at each of the angles within Table 4. The visual notification tool also estimates an illuminance value at an angle that corresponds to a maximum distance from the mounting location to a point within the structure, such as the farthest corner from the mounting location, for example.

TABLE 4

| Angle (Deg) | Polar Output (%) |
|---|---|
| 0 | 100 |
| 5-25 | 90 |
| 30-45 | 75 |
| 50 | 55 |
| 55 | 45 |
| 60 | 40 |
| 65 | 35 |
| 70 | 35 |
| 75 | 30 |
| 80 | 30 |
| 85 | 25 |
| 90 | 25 |

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

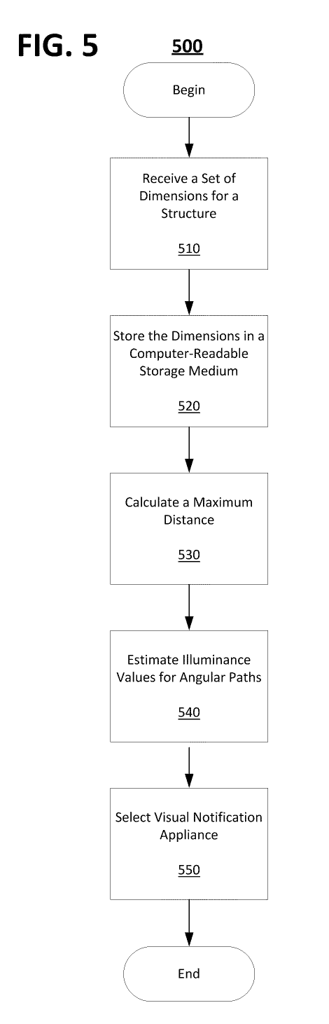

FIG. 5 illustrates one embodiment of a logic flow 500. The logic flow 500 may be representative of some or all of the operations executed by one or more embodiments described herein.

In the illustrated embodiment shown in FIG. 5, the logic flow 500 starts by receiving a set of dimensions for a structure at block 510. The structure may be a room within a building or other structure that requires notification of hazardous conditions. The received dimensions may include a height, width and depth of the structure. The dimensions may be irregular dimensions, such as those not provided for within regulatory guidelines. In addition to the dimensions, a mounting location for a visual notification device may be received. The mounting location may be a wall or ceiling. A location on the wall or ceiling may be estimated using known standards or regulations, or an exact location may be received. The embodiments are not limited by this example.

At block 520, the received dimensions are stored in a computer-readable storage medium, which may include various types of computer-readable storage media, such as a hard disk drive, flash memory, RAM, ROM, or the like.

At block 530 a maximum distance from a mounting location for a visual notification device and a location within the structure is calculated. The maximum distance may be, for example, a distance from the mounting location to the farthest corner of the structure. The maximum distance is calculated using geometric triangulation. Using a known mounting location and the received dimensions, the visual notification tool can calculate the maximum distance from the mounting location to any point within the structure. This maximum distance represents that maximum distance for illumination from a visual notification appliance. An illuminance value may be calculated using the inverse-square law applied to light measurements, set forth within the equation, P=I/D², where P is the illuminance in lumens/ft², I is the effective intensity or candela rating of a visual notification appliance and D is the distance in feet.

At block 540, an estimate is made for illuminance values along a plurality of angular path from the mounting location of a visual notification appliance and points within the structure. The estimated illuminance values may be calculated using the inverse-square law applied to light measurements. For wall mounted visual notification appliances, both vertical and horizontal angular paths need to be estimated. For ceiling mounted visual notification appliances, polar angular paths need to be estimated. For example, the illuminance along angular paths at a predetermined set of angles between 0 degrees and 90 degrees may be estimated. The illuminance at each angular path may be estimated using reduced illuminance at varying angles, as illustrated within Tables 2-4 above. The illuminance is also estimated at an angular path corresponding to a maximum distance from the mounting location to a point within the structure.

At block 550, a visual notification appliance is selected based upon the illuminance value at the calculated maximum distance and the estimated illuminance at each of the angular paths. A visual notification appliance is selected such that a minimum illuminance value is achieved at the maximum distance and at each of the plurality of angular paths. The minimum illuminance value may be set by a safety standard. For example, the minimum illuminance value may be 0.0375 lumens/ft². In an embodiment, a visual notification appliance may be chosen such that it is the least expensive to purchase or least expensive to operate; yet still meet the minimum illuminance value. Further, a predetermined minimum illuminance rating may be set, such as 75cd at a distance of 50 feet on-axis. In this manner, a minimum level of illuminance will be recommended. In addition, a predetermined set of different visual notification appliances or illuminance ratings may be considered. For example, illuminance ratings of 15cd, 30cd, 45cd, 50cd, 60cd, 75cd, 80cd, 95cd, 115cd and 150cd may be considered. The embodiments are not limited by the example.

FIG. 6 illustrates an embodiment of an exemplary computing architecture 600 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 600.

In one embodiment, the computing architecture 600 may comprise or be implemented as part of an electronic device. Examples of an electronic device may include without limitation a mobile device, a personal computer (PC), personal tablet, a server operating locally or on a network, or a combination thereof. The computing architecture 600 includes various common computing elements, such as one or more processors, co-processors, memory units, controllers, peripherals, interfaces, video cards, audio cards, multimedia input/output (I/O) components, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors. Dual microprocessors and other multi-processor architectures may also be employed as the processing unit 604. The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus.

The computing architecture 600 may comprise or implement various articles of manufacture. An article of manufacture may comprise a non-transitory computer-readable storage medium to store logic. Examples of a computer-readable storage medium may include any tangible media capable of storing electronic data. Examples of logic may include executable computer program instructions implemented using any suitable type of code, such as source code, compiled code, interpreted code, executable code, static code, dynamic code, object-oriented code, visual code, and the like.

The system memory 606 may include various types of non-transitory computer-readable storage media in the form of one or more higher speed memory units, such as read-only memory (ROM), random-access memory (RAM), flash memory, magnetic or optical cards, or any other type of media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. The one or more application programs 632, other program modules 634, and program data 636 can include, for example, the visual notification tool described above.

A user can enter commands and information into the computer 602 through one or more wire/wireless input devices, for example, a keyboard 638 and a pointing device, such as a mouse 640. Other input devices may include a microphone, an infra-red (IR) remote control, a joystick, a game pad, a stylus pen, touch screen, or the like. These and other input devices are often connected to the processing unit 604 through an input device interface 642 that is coupled to the system bus 608, but can be connected by other interfaces.

A monitor 644 or other type of display device is also connected to the system bus 608 via an interface, such as a video adaptor 646. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a server computer, a personal computer, portable computer, or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wired and wireless devices or entities using the IEEE 802 family of standards, for example. This includes at least Wi-Fi (or Wireless Fidelity), WiMax, and Bluetooth™ wireless technologies. Thus, the communication can be a predefined structure as with a conventional network or simply an ad hoc communication between at least two devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method for selecting a visual notification appliance, comprising:
receiving a set of dimensions for a structure;
storing, by a processor, the dimensions in a computer-readable storage medium;
calculating, by the processor, a maximum distance between a mounting location for a visual notification appliance and a location within the structure based upon the dimensions;
estimating, by the processor, an illuminance value for each of a plurality of angular paths within the structure; and
selecting a visual notification appliance, wherein the visual notification appliance has an illumination rating that produces a minimum illuminance value at the maximum distance and at each of the plurality of angular paths.

2. The method of claim 1, wherein the set of dimensions includes a width, a height and a depth of the structure.

3. The method of claim 1, wherein the visual notification appliance is a strobe light.

4. The method of claim 1, wherein the minimum illuminance value is 0.0375 lumens/ft².

5. The method of claim 1, wherein the illuminance values are estimated for a plurality of predetermined illumination ratings.

6. The method of claim 5, wherein the predetermined illumination ratings are chosen from the group of 15cd, 30cd, 45cd, 50cd, 60cd, 75cd, 80cd, 95cd, 115cd, and 150cd.

7. The method of claim 1, further comprising the step of:
generating an electronic document according to a document template, the electronic document including the dimensions, calculations performed, estimations performed and the selected visual notification appliance.

8. A computer-readable storage medium comprising instructions that, when executed by a processor, enable the processor to:
receive a set of dimensions for a structure;
store the dimensions in a computer-readable storage medium;
calculate a maximum distance between a mounting location for a visual notification appliance and a location within the structure based upon the dimensions;
estimate an illuminance value for each of a plurality of angular paths within the structure; and
select a visual notification appliance, wherein the visual notification appliance has an illumination rating that produces a minimum illuminance value at the maximum distance and at each of the plurality of angular paths.

9. The computer-readable storage medium of claim 8, wherein the set of dimensions includes a width, a height and a depth of the structure.

10. The computer-readable storage medium of claim 8, wherein the visual notification appliance is a strobe light.

11. The computer-readable storage medium of claim 8, wherein the minimum illuminance value is 0.0375 lumens/ft².

12. The computer-readable storage medium of claim 8, wherein the illuminance values are estimated for a plurality of predetermined illumination ratings.

13. The computer-readable storage medium of claim 12, wherein the predetermined illumination ratings are chosen from the group of 15cd, 30cd, 45cd, 50cd, 60cd, 75cd, 80cd, 95cd, 115cd, and 150cd.

14. The computer-readable storage medium of claim 8, wherein the processor is further enabled to:
generate an electronic document according to a document template, the electronic document including the dimensions, calculations performed, estimations performed and the selected visual notification appliance.

15. A system comprising:
a processor; and
a computer-readable storage medium comprising instructions that, when executed by a processor, enable the processor to:
receive a set of dimensions for a structure;
store the dimensions in a computer-readable storage medium;
calculate a maximum distance between a mounting location for a visual notification appliance and a location within the structure based upon the dimensions;
estimate an illuminance value for each of a plurality of angular paths within the structure; and
select a visual notification appliance, wherein the visual notification appliance has an illumination rating that produces a minimum illuminance value at the maximum distance and at each of the plurality of angular paths.

16. The system of claim 15, wherein the set of dimensions includes a width, a height and a depth of the structure.

17. The system of claim 15, wherein the visual notification appliance is a strobe light.

18. The system of claim 15, wherein the minimum illuminance value is 0.0375 lumens/ft².

19. The system of claim 15, wherein the illuminance values are estimated for a plurality of predetermined illumination ratings.

20. The system of claim 19, wherein the predetermined illumination ratings are chosen from the group of 15cd, 30cd, 45cd, 50cd, 60cd, 75cd, 80cd, 95cd, 115cd, and 150cd.

21. The system of claim 15, wherein the processor is further enabled to:
generate an electronic document according to a document template, the electronic document including the dimensions, calculations performed, estimations performed and the selected visual notification appliance.
